(19) United States
(12) Patent Application Publication
(10) Pub. No.: US 2015/0375193 A1
(43) Pub. Date: Dec. 31, 2015

(54) PLASMA DISSOCIATION OF HYDROGEN SULFIDE IN THE PRESENCE OF OXYGEN

(71) Applicants: DREXEL UNIVERSITY, Philadelphia, PA (US); CHEVRON ENERGY TECHNOLOGY COMPANY, Richmond, CA (US)

(72) Inventors: Thomas Nunnally, Philadelphia, PA (US); Kirill Gutsol, Philadelphia, PA (US); Alexander Rabinovich, Cherry Hill, NJ (US); Alexander Fridman, Philadelphia, PA (US); Alexander F. Gutsol, Lafayette, CA (US)

(21) Appl. No.: 14/769,129

(22) PCT Filed: Mar. 4, 2014
(86) PCT No.: PCT/US14/20200

§ 371 Date: Aug. 20, 2015

Related U.S. Application Data
(60) Provisional application No. 61/772,122, filed on Mar. 4, 2013.

(51) Int. Cl. B01J 19/08; C01B 17/04; C01B 3/04

(52) U.S. Cl. CPC B01J 19/088; C01B 3/04; C01B 17/0495

(57) ABSTRACT

Methods of producing hydrogen and sulfur from the destruction of hydrogen sulfide are provided, each method comprising subjecting hydrogen sulfide (H₂S) to a non-thermal plasma in the presence of oxygen (O₂), under the specific conditions articulated herein, so as to provide hydrogen at a specific energy requirement of less than about 2.5 eV/molecule of H₂.

### CROSS REFERENCE TO RELATED APPLICATIONS

This application claims the benefit of U.S. Provisional Application No. 61/772,122, filed Mar. 4, 2013, the entirety of which is incorporated by reference herein for all purposes.

### TECHNICAL FIELD

The present invention relates to the application of non-thermal plasma to generate hydrogen from hydrogen sulfide.

### BACKGROUND

H₂S is a byproduct of oil refinement and also comprises a significant portion of natural gas deposits. Therefore, efficient H₂S treatment and utilization is crucial to the oil and gas industry. The traditional method of H₂S treatment employs the Claus process. There are two stages of sulfur recovery in the Claus process. The first is a thermal step, in which H₂S is partially oxidized with air

3H₂S+3/2O₂→α(3/2S₂+3H₂O)+(1−α)(SO₂+2H₂S+H₂O) (1-1)

This step occurs in a furnace at high temperatures of 1,300-1,700 K. The main product are sulfur (α=60-70%) and water; however, because of the high temperatures of the reaction, SO₂ is also formed. Consequently, a second step is necessary

2H₂S+SO₂→3S+2H₂O (1-2)

In order for (1-2) to occur at reasonable speeds, a catalyst is required. Even with the best catalyst, the reaction is not complete. Thus, it is operated in two or three stages with intermediate sulfur condensation. Finally, in order to remove all H₂S from the tail gas, it is often necessary to follow the Claus unit with a tail gas cleanup unit.

Ultimately, all hydrogen in the H₂S is converted to water. Conversion of the hydrogen to water, however, is wasteful from the standpoint of thermodynamics because H₂S can be a cost effective source of hydrogen. The dissociation energy of H₂S (into hydrogen and solid sulfur) is only 0.2 eV per molecule. Compared to water, which has dissociation energy of 2.9 eV per molecule, production of hydrogen from H₂S is 15 times less costly. Therefore, the possibility to dissociate H₂S into sulfur and hydrogen is important commercially. Such prospects are particularly important for oil industry, which consumes large amounts of hydrogen in oil hydro-treatment for production of low sulfur fuels and could benefit from a low cost method of H₂S dissociation.

The present invention provides a means for reducing hydrogen sulfide from waste streams, while providing for the clean, energy efficient recovery of hydrogen gas from its destruction.

### SUMMARY

Methods of producing hydrogen and sulfur from the destruction of hydrogen sulfide are provided, each method comprising subjecting hydrogen sulfide (H₂S) to plasma processing in the presence of oxygen (O₂), under the specific conditions articulated herein, so as to provide hydrogen at a specific energy requirement of less than about 2.5 eV/molecule of H₂. In certain embodiments, the product contains very low levels of SO₂.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 illustrates the Specific Energy Requirement (SER) in eV/molecule (dashed line) and hydrogen yield in percent (solid line) depending on temperature at equilibrium conditions, as described in Example 1.

FIG. 2 shows schematic representations for reactors useful in the present invention, as discussed in Example 1. FIG. 2A shows tangential premixing of H₂S and O₂ and FIG. 2B shows axial addition of O₂ into the reactor hot zone.

FIG. 3A shows Temperature vs. Specific Energy Input (SEI), FIG. 3B shows H₂S Concentration vs. Specific Energy Input, FIG. 3C shows H₂ Concentration vs. Specific Energy Input, FIG. 3D shows H₂O Concentration vs. Specific Energy Input, and FIG. 3E shows SO₂ Concentration vs. Specific Energy Input at 10% (dashed) and 20% (dotted) O₂ addition for modeling results, as described in Example 2.

FIG. 4 shows results of thermodynamic modeling of SER for H₂ Production and H₂S Destruction vs. Specific Energy Input for varying oxygen addition, as described in Example 2.2.

FIG. 5 shows V-I characteristics for tangential and axial O₂ addition in GAP with 8.6 L/min H₂S flow rate, as described in Example 4.1. Results for pure H₂S are also included.

FIG. 6 shows comparison of SER for H₂ production for axial and tangential O₂ addition in GAP. Pure H₂S is also included, as described in Example 4.1. Results for pure H₂S are also included.

FIG. 7 shows a comparison of exhaust gas O₂ yield in GAT (with varying O₂ addition) and GAP (axial addition), as described in Example 4.2.

FIG. 8 shows a comparison of H₂ yield in GAT (varying O₂ addition) with thermodynamic modeling H₂ yield, as described in Example 4.2.

FIG. 9 shows a comparison of H₂S destruction in GAT (varying O₂ addition) with thermodynamic modeling H₂S destruction, as described in Example 4.2.

FIG. 10 shows a comparison of H₂O yield in GAT (varying O₂ addition) with thermodynamic modeling H₂O yield, as described in Example 4.2.

FIG. 11 shows a comparison of SER vs. SEI in GAT with 10% oxygen addition (dots—pure H₂S, square—10% O₂ addition H₂ production SER, triangle—10% O₂ addition H₂S destruction SER) with thermodynamic modeling (dotted line—10% O₂ addition H₂ production SER, dashed line—10% O₂ addition H₂S destruction SER, solid line—pure H₂S), as described in Example 4.3.

FIG. 12 shows a comparison of SER vs. SEI in GAT with 20% oxygen addition (dots—pure H₂S, diamond—20% O₂ addition H₂ production SER, circle—20% O₂ addition H₂S destruction SER) with thermodynamic modeling (dotted/dashed line—20% O₂ addition H₂ production SER, dashed line—20% O₂ addition H₂S destruction SER, solid line—pure H₂S), as described in Example 4.3.

FIG. 13 shows Specific Energy Requirement vs. Specific Energy Input for an air admixture providing 10% O₂ to the system, as described in Example 4.4.

FIG. 14 shows H₂ Yield vs. Specific Energy Requirement for pure H₂S and oxygen admixtures, as described in Example 5.

FIG. 15 shows H₂S Destruction vs. Specific Energy Requirement for pure H₂S and oxygen admixtures, as described in Example 5.

### DETAILED DESCRIPTION OF ILLUSTRATIVE EMBODIMENTS

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the methods of dissociating hydrogen sulfide, as well as the equipment necessary to realize the methods themselves, and vice versa.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

When a list is presented, unless stated otherwise, it is to be understood that each individual element of that list and every combination of that list is to be interpreted as a separate embodiment. For example, a list of embodiments presented as “A, B, or C” is to be interpreted as including the individual embodiments, “A,” “B,” “C,” “A or B,” “A or C,” “B or C,” or “A, B, or C.” In this regard, for example, an embodiment presented as “a method comprising injecting a stream of hydrogen sulfide (H₂S)-containing gas and a stream of oxygen (O₂) or oxygen-rich gas into a reactor, said reactor having a plasma zone therein,” where plasma is defined within the specification as including thermal and non-thermal plasma, or a combination of both, said presented embodiment should be interpreted as presenting separate individual embodiments wherein the gases are injected into a reactor having a zone comprising (a) a thermal plasma; (b) a non-thermal plasma; and (c) a combination of thermal and non-thermal plasma.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step or part may also be considered an independent embodiment in itself.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein.

The present invention includes a range of embodiments as methods for producing hydrogen and sulfur from hydrogen sulfide and oxygen, each method comprising:
injecting a stream of hydrogen sulfide (H₂S)-containing gas and a stream of oxygen (O₂) or oxygen-rich gas into a reactor, said reactor having a plasma zone therein;
said gas streams being wholly or partially combined with one another before or during contact with the plasma;
wherein the molar ratio of hydrogen sulfide to oxygen injected into the reactor is in a range of from about 3 to about 100; and
said plasma providing an energy to the reactor with the H₂S/O₂ gas streams in a range of about 0.1 to about 1.5 eV per H₂S molecule;
said method providing hydrogen at a specific energy requirement of less than about 2.5 eV/molecule of H₂.

The present inventors have discovered that the addition of small amounts of oxygen to the plasma dissociation of hydrogen sulfide dramatically reduces the specific energy required to generate hydrogen, below the thermodynamic equilibrium calculated energy requirement under the same nominal conditions, while maintaining good H₂S destruction efficiencies.

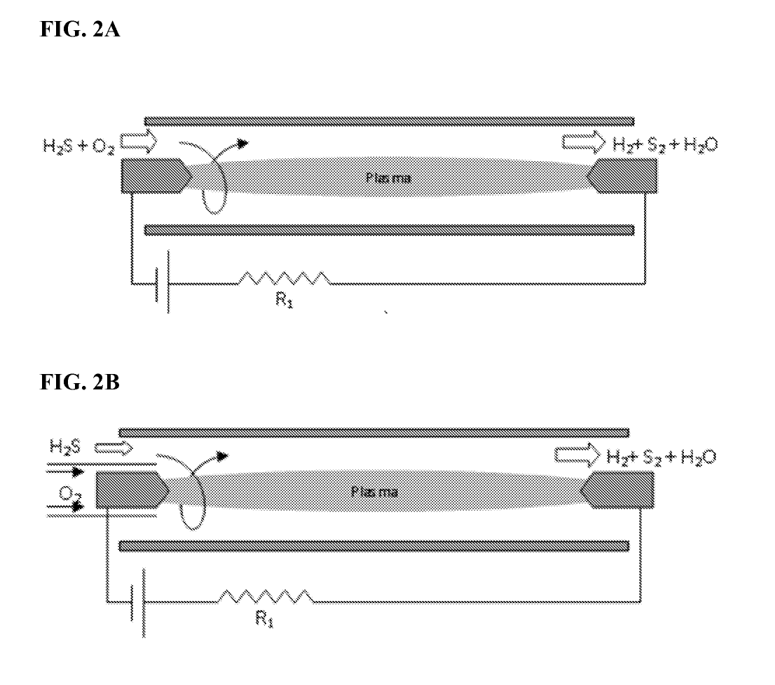

The reactors suitable for accomplishing these methods include those previously described for use for the application of plasma—for example, as described in WO 2008/137936, WO 2010/141496, U.S. Pat. Nos. 7,867,457 and 8,110,155, U.S. Pat. App. Pub. Nos. 2010/0300872 and 2012/0090985, U.S. Pat. App. No. 60/916,562 and its progeny, and Gutsol, et al., “Plasma assisted dissociation of hydrogen sulfide,” Intl. J. Hydrogen Energy. 37 (2012) 1335-1347, each of which is incorporated by reference herein for all teachings. In some cases, these publications speak generally to reactor designs capable of accommodating multiple gas inlets, but do not teach or suggest the specific conditions described in the present invention. The present methods are flexible within the scope of reactors described for the dissociation of hydrogen sulfide, and the following represent several exemplary, non-limiting configurations contemplated by the present invention (each figure should be read in the context of the corresponding reference; i.e., the specific element number references may be found in the corresponding reference). For example, the reactors include those described in U.S. Pat. Nos. 7,867,457 and 8,110,155; U.S. Pat. App. No. 60/916,562 and its progeny; U.S. Pat. App. Pub. No. 2012/0090985; WO 2008/137936; in Intl. J. Hydrogen Energy, 37 (2012) 335-4347; and FIG. 2 herein.

In various embodiments, the reactors may be cylindrical or substantially cylindrical, and (as illustrated above) may be oriented in any spatial arrangement. In some embodiments, the reactors useful for the inventive methods may be described as tornado reactor or plasmatron reactors. The reactors should be constructed of materials compatible with the reaction chemistries associated with plasma, hydrogen sulfide, hydrogen, oxygen, and sulfur, and so may be comprise quartz, stainless steel, or steel alloy, such as Inconel.

In some embodiments, the reactors are oriented such that the electrodes are positioned vertically with respect to one another; in other embodiments, the electrodes are positioned horizontally or any convenient orientation with respect to one another. A vertical arrangement may be preferred for reasons provided below.

The reactors may contain features which aid in the movement of the injected starting materials, as well as the removal of products, once formed. For example, as at least in the reactors described in WO 2008/137936 and WO 2010/141496, reactors of the present invention may comprise injection ports that provide for tangential injection of the starting materials, in some cases using additional swirl generators. As shown above, these tangential injectors are suitable for either vertical or horizontally oriented reactors, and may provide for the injection of the starting materials at either end of the reactors. In some embodiments, the some or all of the source gases may be introduced into the reaction chamber at or near sonic velocity having mostly the tangential component of the velocity vector.

In certain embodiments, the reactors provide for outlet ports, positioned for example at the highest position in the reactor, to allow the lighter hydrogen products and residual input gases to escape with minimal need for additional mechanical exhausting.

Unless otherwise stated, the term “hydrogen sulfide (H₂S)-containing gas” refers (as may be self-evident) to a feedstock containing H₂S, either as a sole component or admixed with other hydrocarbon or inert materials. In certain separate embodiments, the hydrogen sulfide content of this hydrogen sulfide (H₂S)-containing gas is at least about 50 wt %, at least about 60 wt %, at least about 70 wt %, at least about 80 wt %, at least about 90 wt %, or at least about 95 wt %, relative to the total weight of the gas. In certain of these embodiments, the balance is mainly (greater than about 50%) or entirely inert ballast gas (e.g., nitrogen), inert referring to its substantial non-reactivity under the conditions employed herein. The term “oxygen-rich gas” refers to a gas mixture containing more than 50 wt % oxygen, relative to the total weight of the gas. Often, such gas may comprise air which has been enriched in oxygen. In certain separate embodiments, the oxygen content of this oxygen-rich gas is at least about 50 mol %, at least about 60 mol %, at least about 70 mol %, at least about 80 mol %, at least about 90 mol %, or at least about 95 mol %, the balance being mainly (greater than about 50%) or entirely inert ballast gas (e.g., nitrogen), inert being defined as above. In other embodiments, the oxygen-rich gas stream contain less than about 50 mol %, less than about 30 mol %, less than about 20 mol %, less than about 10 mol %, or less than about 5 mol % of an inert ballast gas.

In certain embodiments, the streams of hydrogen sulfide (H₂S) gas and streams of oxygen (O₂) or oxygen-rich gas may be premixed before entering the reactor; in other cases, the two types of streams are injected into the reactor individually. Generally, though not necessarily, the hydrogen sulfide (H₂S) gas and oxygen (O₂) or oxygen-rich gas streams are directionally injected into the reactor so as to form a vortex flow of gases within the reactor. In other arrangements, the gas streams are directed and the reactor configured to provide for a reverse-vortex flow. By suitable positioning of the electrodes, injection portals and reactor outlets, the gas streams can be directed to position the plasma zone at or near an axis of the reaction chamber (as illustrated above). Such an arrangement provides for a central region of hot plasma and a relatively cold flow around this zone within the reactor. In some embodiments, at least one of the gas streams (H₂S or O₂ containing streams) is injected, not directly into the relatively hot plasma, but into the relatively cold zone of the reactor. The heat from the plasma and oxidation in the hot zone results in partial dissociation of H₂S in the surrounding relatively cold zone. In other embodiments, the stream oxygen (O₂) or oxygen-rich gas is injected directly into the hot plasma zone, separately from at least a part of the H₂S stream. Without intending to be bound to the correctness or incorrectness of any particular theory, this appears to impart an enhanced chemical energy to the plasma, which provides for the enhanced performance during the dissociation of at least a portion of the hydrogen sulfide to gaseous sulfur and gaseous hydrogen.

The efficiency of the system may be improved by maintaining the inner surface of the reactor at a temperature lower than that of the hot plasma zone, so as to establish an axial temperature differential across the reaction chamber. This temperature gradient, coupled with the high tangential velocities of the gas streams directed within the reactor, provides for the migration of the gaseous sulfur radially outward towards an inner surface of the reaction chamber. By maintaining the temperature of the reactor sidewall at a lower temperature (preferably below the condensation temperature of the gaseous sulfur), the product sulfur gas does condense on the inner sidewalls of the reactor, as it approach to or contact with the inner surface, thereby quenching the reaction kinetics with respect to the sulfur and removing the sulfur from the reaction mixture. In certain embodiments, the reactor is configured so that at least a portion of this condensation energy is returned to the reaction chamber, to reduce any energy loss from the reaction dynamics.

In some embodiments, the reactors are constructed and oriented such that the sidewalls are accessible and in fluid communication with either a collection tank outside the reactor or a receiver at the bottom of the reactor, such that the sulfur is able to drain downward into either by the force of gravity (as shown above).

To this point, the various embodiments have been described as methods employing “plasma,” and in some embodiments, this term refers either to thermal (equilibrium) or non-thermal (non-equilibrium) plasma, or a combination of the two types of plasma. Note that, at least as used herein, the terms “thermal” and “equilibrium” as applied to “plasma” are interchangeable, as are the terms “non-thermal” and “non-equilibrium.” Each of these types of plasmas can provide separate independent embodiments, in conjunction with the other features. Thermal plasmas may be employed in spatially non-uniform systems, where the plasma do not contact the reactor boundaries. But non-equilibrium plasmas are preferred when the plasma systems are “uniform” and in contact with the reactor boundaries, because they are less apt to destroy the reactor boundaries. Thermal plasmas operate at temperatures often exceeding 10,000K, while non-equilibrium plasmas operate with gas phase temperatures as low as ambient room temperature, but for present purposes, conditions are chosen to provide an operating temperature in a range of from about 800K to about 4000K. Non-equilibrium plasmas, operating at the lower end of the temperature range are preferred for reasons of energy consumption and reactor stability.

The various embodiments thus far have been described as methods, each method comprising injecting a stream of hydrogen sulfide (H₂S)-containing gas and a stream of oxygen (O₂) or oxygen-rich gas into a reactor, said plasma providing an energy to the reactor with the H₂S/O₂ gas streams in a range of about 0.1 to about 1.5 eV per H₂S molecule. Other embodiments provide that the energy provided by the plasma be in a range having a value at the lower end of about 0.1, about 0.2, about 0.3, about 0.4, and about 0.5 eV per H₂S molecule, and having a value at the upper end of about 1.5, about 1.4, about 1.3, about 1.2, about 1.1, or about 1.0 eV per H₂S molecule. Exemplary ranges within these limits include those where the range is from about 0.2 to about 1 eV or from about 0.2 to about 0.5 eV per H₂S molecule.

In those embodiments where the plasmas are non-equilibrium plasma, the plasma may be generated using any suitable mode of discharge, for example including gliding arc discharge, rotating gliding arc discharge, low current arc discharge, corona discharge, glow discharge, dielectric barrier discharge, spark discharge, pulsed corona, radio-frequency capacitively or inductively coupled discharge, or microwave discharge. Gliding arc discharge plasma is a preferred non-equilibrium discharge for the present methods. To achieve a gliding arc type of discharge, the electrodes may be configured so as to be moveable with respect to one another (providing that the length of the discharge may be varied by pulling one electrode away from the other once the discharge is initiated), or the two electrodes may simply have a variable gap between them. For example, in some embodiments, a first electrode is positioned at one end of the reactor, and a second electrode is positioned at the other end or remote (from the first electrode) and in electrical communication with a metallic sidewall of the reactor or to an antenna positioned transverse to the first electrode, such as described in the above references. In such arrangements, the length between the first and along the second electrode is non-constant, providing for a design consistent with gliding arc plasma.

The methods of the present invention may be operated at a range of pressures, and certain embodiments provide these methods operating at absolute pressures in a range having a lower value of about 0.5 atm, about 1 atm, about 2 atm, about 3 atm, about 4 atm, or about 5 atm, and having an upper value of about 10 atm, about 9 atm, about 8 atm, about 7 atm, about 6 atm, or about 5 atm. Exemplary ranges include those from about 0.5 to about 10 atm, from about 1 atm to about 4 atm, and from about 1 atm to about 2 atm.

The methods have thus far been described in terms of injecting a stream of hydrogen sulfide (H₂S)-containing gas and a stream of oxygen (O₂) or oxygen-rich gas into a reactor, wherein the molar ratio of hydrogen sulfide to oxygen injected into the reactor is in a range of from about 3 to about 100. Additional embodiments provide methods wherein the molar ratio of hydrogen sulfide to oxygen injected into the reactor is in a range having a lower value of about 4, about 5, about 6, about 7, about 8, about 9, or about 10, and an upper value of about 100, about 75, or about 50, or about 30 with another exemplary, non-limiting range of from about 4 to about 30. These ratios are exemplified in the Examples.

Additional embodiments provide methods where the ratios of H₂S to O₂ (or vice versa) are described in terms of volume ratios (equivalent to molar ratios where the two gases are introduced at constant temperatures). Still other embodiments provide methods where these ratios are described in terms of mass or weight ratios. Note that the molecular weights of H₂S (MW ca. 34) and O₂ (MW ca. 32) differ only by about 5%, any expression of a ratio of these two molecules in molar terms vs. mass terms would be essentially equivalent in most practical situations.

### EXAMPLES

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees K.

### Example 1

### Rationale

There are many approaches for H₂S dissociation. Among these are photochemical, direct electrochemical, indirect electrochemical, thermal (catalytic and non-catalytic) and plasma systems. The economics of such systems have been reviewed. Photochemical methods were not very successful because of high energy costs and low conversion. Electrolysis encounters many problems including sulfur passivation of the anode. Electrochemical processes require chemical oxidants and have high electrical energy requirements.

In general, thermal decomposition and plasma systems have more potential than other approaches because they have lower energy consumption. Hydrogen sulfide dissociation with hydrogen and elemental sulfur production is slightly endothermic:

H₂S→H₂+S_{solid}, ΔH=0.2 eV/molecule (1-4)

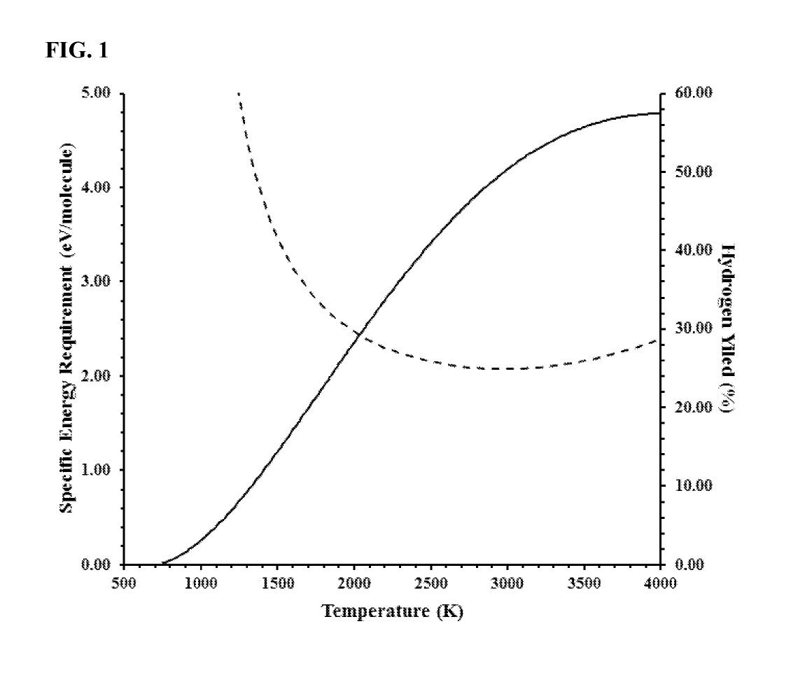

Unfortunately, it is not possible to produce solid sulfur through thermal dissociation of H₂S. Thermodynamic equilibrium simulation, which is in agreement with previous works, indicates that H₂S can be dissociated to H₂ and gaseous S₂ with reasonable conversion only at rather high temperatures (FIG. 1).

The existing theoretical basis for H₂S dissociation was developed in the 1980's, when detailed kinetic simulations were difficult because of the limited availability of computational power and kinetic data. Ultimately, researchers concluded that the process was defined by equilibrium heating. The traditional kinetic scheme of H₂S dissociation includes one endothermic reaction:

H₂S+M [symbol] HS+H+M, ΔH₂₉₈=379 kJ/mole=3.93 eV/molecule, (1-5)

which is the limiting reaction in the scheme, and several fast exothermic reactions:

H+H₂S [symbol] H₂+HS, ΔH₂₉₈=57 kJ/mole=0.59 eV/molecule (1-6)

HS+HS [symbol] H₂+S₂, ΔH₂₉₈=152 kJ/mole=1.58 eV/molecule (1-7)

Or

HS+HS [symbol] H₂S+S, ΔH₂₉₈=24 kJ/mole=0.25 eV/molecule (1-8)

H₂S+S [symbol] H₂+S₂, ΔH₂₉₈=128 kJ/mole=1.33 eV/molecule (1-9)

As a result, it is necessary to spend 3.93 eV to dissociate two molecules of H₂S, which is equivalent to SER of hydrogen production of at least 1.965 eV/molecule. Thermodynamic equilibrium modeling, with the assumption of plug flow reactor with fast product quenching, indicates that the lowest SER that can be expected is 2.04 eV per molecule (FIG. 1). Table 1 shows the composition of an equilibrium H₂S mixture at minimum SER (species with mole fraction lower than 0.1% omitted).

TABLE 1
Composition of an equilibrium H₂S mixture at minimum SER
(T = 2900 K at P = 1 bar) (species with mole
fraction lower than 0.1% omitted)

| Mixture Species | Mole Fraction |
|---|---|
| H₂S | 22.0 |
| HS | 1.9 |
| H₂ | 51.0 |
| S₂ | 25.0 |

An alternative approach that has been applied to H₂S dissociation is the gliding arc discharge. A gliding arc discharge can exist in a non-equilibrium regime with electronic, vibrational, and translational gas temperatures of 10,000, 2,000-3,000, and 800-2100 K respectively. Such a regime is suitable for many fuel conversion processes. One of the more sophisticated gliding arc discharges is the Gliding Arc in Tornado (GAT). The discharge was initially developed for natural gas partial oxidation and utilizes a gliding arc plasma discharge in reverse vortex flow, RVF.

The concept described herein is that H₂S destruction can be assisted by hydrogen oxidation, to achieve a reduction in electrical energy cost and an increase in conversion:

2H₂+O₂→2H₂O (1-3)

This reaction is exothermic, and thus, the admixture of a small amount of oxygen to a H₂S stream or to the reaction zone (FIGS. 2A and B) might result in additional energy release and consequently a reduction in specific energy cost. This process is similar in some extent to the first stage of the Claus process (1-2), however the important difference is that the Claus process uses large quantities of oxygen, while the plasma system uses a small amount (approximately 10% of the overall mixture).

A number of other important differences exist between this plasma process and the Claus process. One difference is that the plasma system can be made spatially non-uniform. In addition, the plasma process can be combined with surface catalysis, which can accelerate the partial oxidation reaction at reduced temperature (and lower O₂ concentration) and prevent formation of sulfur dioxide. Overall, the plasma system is much more flexible when compared with the Claus process.

### Example 2

### Thermodynamic Modeling of H₂S—O₂ Mixtures

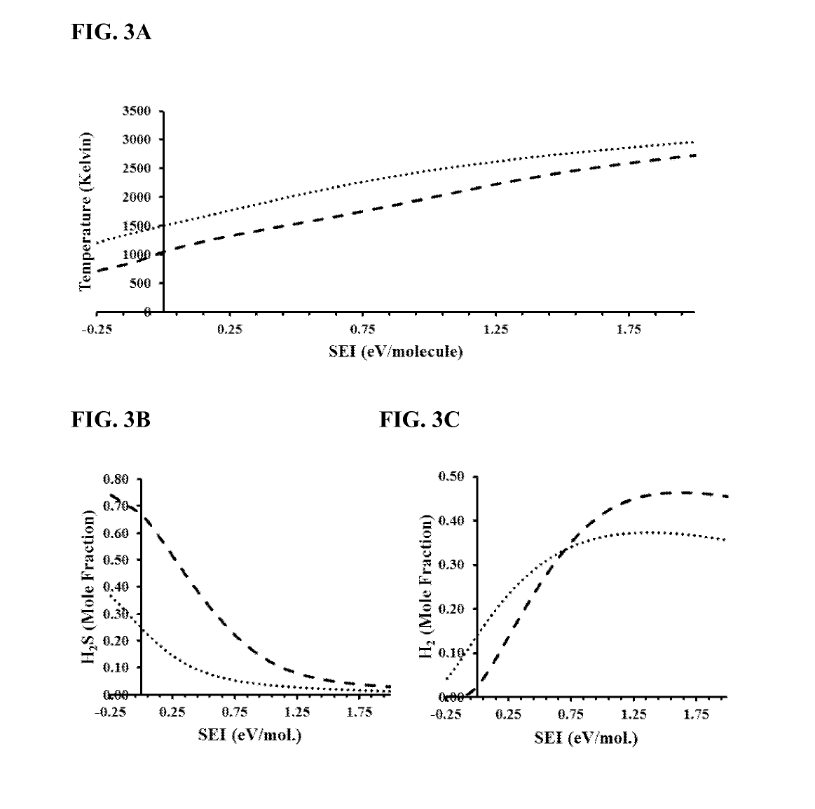

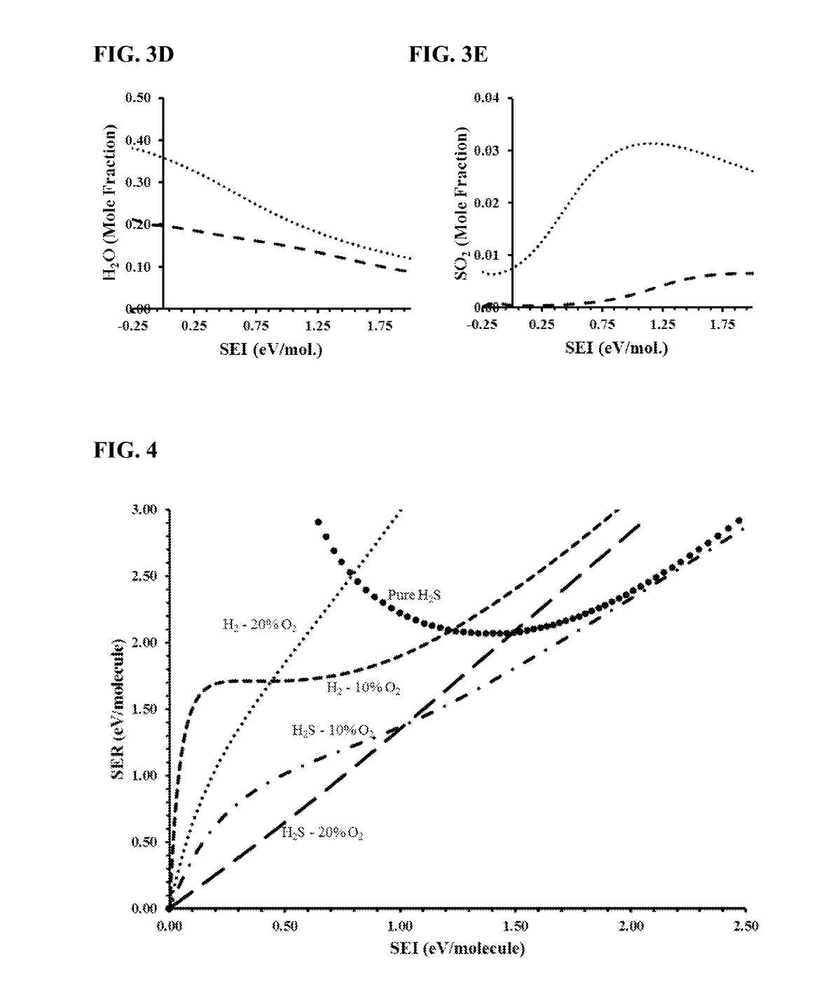

Modeling was performed comparing product composition and specific energy requirement for varying specific energy input and O₂ addition (FIG. 3). The thermodynamic equilibrium mixture composition for pure H₂S is also shown for comparison. The modeling was performed using the Chemkin® 4.1.1 software suite adiabatic plug flow reactor. Temperature was varied from 725 K to 3000 K for O₂ admixtures of 1-20%.

### Example 2.1

### Effect of Oxygen Addition on Gas Composition

The relationship found between temperature and specific energy input was provided in FIG. 3A. A significant temperature increase is observed with oxygen addition, even at zero SEI.

The relationship found between H₂S concentration and specific energy input is provided in FIG. 3B. Addition of oxygen to H₂S resulted in exothermic reactions that released energy and increased temperature, which resulted in conversion of H₂S, similar to the Claus process. Significant oxygen addition was found to cause hydrogen production without addition of electric energy (FIG. 3C).

Partial oxidation of H₂S will also result in significant production of H₂O. As might be expected, considerably more H₂O was produced at higher oxygen addition (FIG. 3D). This effect was most notable at lower SEI (lower temperature); however, as SEI increased, oxygen concentrations began to converge to low values. If SEI is large enough, no H₂O would remain because it would thermally decompose.

Since a significant portion of oxygen is added into the system, SOₓ should be produced. The main form of SOₓ that is produced will be SO₂. SO₂ presents problems because of safety concerns; however, from the standpoint of industry, the production of SO₂ is not a problem, as equipment is already available to mitigate its effects. Still, low SO₂ is certainly desirable from the viewpoint of safety and processing cost. In the modeling of this study, only a small concentration of SO₂ was produced, even at the highest quantity of oxygen addition (FIG. 3E). Modeling predicted a maximum of 3.2% production at 20% oxygen addition. In the case of 10% oxygen addition, approximately 1% was predicted.

### Example 2.2

### Effect of Oxygen Addition on Specific Energy Requirement

One of the most important parameters to study was SER for H₂ production. It was necessary to confirm that costs for H₂ production were still low in the case of oxygen addition. The results of modeling for this parameter at varying oxygen addition are presented in FIG. 4. For the case of 10% oxygen addition, significant reduction in SER was predicted. In the range SEI 0.1-0.5 eV/molecule, a SER of 1.7 eV/molecule was predicted. Even lower values are predicted at 20% oxygen addition at low SEI. For the case of 10-20% oxygen addition, SER decreased to zero at a SEI=0 eV/molecule. This was possible for the same reason that was explained in Example 2.1. The modeling predictions were important because they indicated that there was a possibility to dramatically reduce SER for H₂ production at low SEI.

SER for H₂S removal was a new parameter, which arose because the cost of H₂S destruction in this study was not the same as the cost of H₂ production. This occurred because the addition of oxygen resulted in the consumption of produced H₂ and an increase in temperature. More H₂S was destroyed than H₂ was produced. As a result, SER for H₂S removal could be significantly lower than that of SER for H₂ production.

Modeling predicted very low SER, less than 0.8 eV/molecule, for H₂S removal at SEI less than 0.5 eV/molecule (FIG. 4). Similar to the predictions for SER for H₂ production, SER decreased to zero at a SEI=0 eV/molecule. Thus, modeling predicted very low SER for H₂S removal at very low SEI. It should be noted that, while this process could be of interest, it is not easily achieved because a single, pure combustion zone is not well controlled and often results in system degradation and destruction. Plasma systems, on the other hand, have distinct, separate zones, which ensure reactor integrity. This can be considered one of the primary advantages of utilizing a plasma system instead of pure combustion. Also, it is important to recall that rather high SEI (>0.5 eV/molecule) is necessary for high conversion, which is desirable in the process (see FIG. 3B).

In summary, based on this modeling, it was possible to conclude that at low SEI on the order of 0.3 to 0.7 eV/molecule, one may expect rather high H₂S conversion, 50%, and H₂ yield, 30%, at rather low SER, 1 eV/molecule. The values of the parameters appeared more promising than those for pure H₂S dissociation.

### Example 3

### Experiment

Upon completion of modeling, experiments were conducted using information gained from thermodynamic modeling. Results from modeling indicated that oxygen addition on the order of 10-20% of the overall mixture should have the most potential influence on the process parameters; thus, studies in the following sections focused on that range.

### Example 3.1

### Experimental Scheme

A laboratory scale system for H₂S dissociation in oxygen admixtures was used. Gas exiting the plasma reactor was a mixture of H₂S, H₂, H₂O, O₂ and gaseous and solid sulfur. This mixture passed through a sulfur condensation chamber where most sulfur condensed. A sulfur filter made of ceramic wool separated and caught any remaining sulfur. The final exhaust gas was treated using a sodium hydroxide (NaOH) wet scrubber. The reaction produced an aqueous solution of sodium hydrosulfide, NaSH, and water according to:

NaOH_{ag}+H₂O_{iiquid}+H₂S→NaSH_{ag}+H₂O_{liquid} (3-1)

Two plasma reactors were used in the study. The experimental setup remained the same through all the experiments, and only the reactor was changed. One reactor, the Gliding Arc in Tornado, GAT, was used. A second reactor, the Gliding Arc Plasmatron, GAP, combined the compact design of previous plasmatron fuel reformers with the reverse vortex flow (RVF) effects previously reported for “tornado” discharges. The GAP design was more desirable from a practical standpoint because the walls of the reactor were made of stainless steel (rather than quartz) allowing for a more robust reactor. The reactor can operate at low to atmospheric pressure, and could have preheating of the gas if desired. Gas flow rates could vary in the range of 1-60 L/min. In the case of GAP, an additional method of injection could be employed where oxygen was injected axially into the reactor hot zone (GAT is only capable of providing tangential gas injection).

### Example 3.2

### Instruments and Equipment

The high voltage electrode in each reactor was connected to a power supply (Quinta, Ltd.) specially designed for gliding arc applications. It was designed as a source of controlled and stabilized power that can provide open-circuit (ignition) voltage up to 15 kV, and operational power up to 1 kW with working voltage up to 7.5 kV. To limit the gliding arc current, the power supply utilized a concept known as reactive capacitive resistance that allows for control of the alternating current value. This prevented high energy losses typical for a more traditional network of ballast resistors; however, it did not allow for effective current rectification. Therefore the power supply voltage could be characterized as unipolar oscillatory.

The power supply provided measurement of the average current and voltage, and the product of these values provided a power value with accuracy of 15% (as determined by special experiments with power integration using a high frequency oscilloscope, Tektronics TDS5052B). Power variation in a range of 150-700 W corresponded to average current variation in the range of 100-400 mA, and average voltage variation in a range of 1.0-3.0 kV.

Flow rates were measured and controlled using rotameters (Omega), which had full scale accuracy of 2%.

A dry basis analysis of gas composition was made using a gas chromatograph (Agilent 3000 Micro-GC) using a thermal conductivity detector. Two separate columns were used; the Agilent HP-PLOT Molsieve column for detection of H₂, O₂ and N₂; and the Agilent GS-GasPro column for detection of H₂S, SO₂. Nitrogen and oxygen were detected because a small amount of air was always collected during low pressure sampling. The N₂ and O₂ were always in same relative concentration, and the overall molar fraction did not exceed 4%. SO₂ was measured with a detection limit of 0.01%. Anything below this value cannot be detected, at least not with any reliability. Undoubtedly, H₂O was produced in these experiments; however, the GC could not provide measurements for H₂O. Still, this production must be accounted for, and will be discussed in the following two sections. The concentrations obtained from the Micro-GC were used in calculations.

### Example 3.3

### Important Parameters and Calculations

The dissociation of H₂S was studied varying power and oxygen addition. The optimal flow rate of H₂S at atmospheric pressure, 14 L/min, was used in all experiments. Results are expressed in terms of percent of gas production and/or destruction, gas flow rate, specific energy input, and specific energy requirement for H₂ production and H₂S destruction. In most experiments, flow rate and oxygen addition were kept constant while power was varied. Energy cost (SER) was determined by first calculating the specific energy input, SEI. SEI is the total energy consumption in a plasma-chemical process per unit of reagent and can be determined via SEI=P/Q=J, where P is the power in the plasma discharge and Q is the gas flow rate of H₂S. SEI can be expressed in units of kW-h/m³, kJ/mol, MJ/kg, or eV/molecule. Since a significant quantity of water was produced, which was not detectable by the GC, a special method was developed for water quantification. This method is described in detail in the next section.

### Example 3.4

### Water Production Quantification and Calculation

Unfortunately, all products in the experiments could not be analyzed via gas chromatography. Specifically, water, which can be significant in the case of oxygen admixtures, cannot be measured. Fortunately, the water can be accounted for accurately via the known GC measurements and balance equations.

The reaction in H₂S and O₂ mixtures can be summarized by:

aH₂S+bO₂→cH₂S+dO₂+eH₂+fSO₂+gH₂O+hS₂ (3-2)

The following three known equations from GC measurements are:

d/c=[O₂]/[H₂S] (3-3)

e/c=[H₂]/[H₂S] (3-4)

f/c=[SO₂]/[H₂S] (3-5)

Here, [A] is the volume concentration of the substance A measured by the gas chromatograph. The summary equation is thus reduced to three unknowns, and three additional equations are required to solve the system. The three equations are the balance equations from Hydrogen, Sulfur and Oxygen respectively:

2a=2c+2e+2g (3-6)

a=c+f+2h (3-7)

2b=2d+2f+g (3-8)

With these equations, all unknowns can be determined.

When determining SER, the values are calculated based on flow rates. Consequently, the parameters must reflect this and are provided below for H₂ yield (a_{H}_{₂}), SER for H₂ production (Σ_{H}_{₂}), and SER for H₂S removal (Σ_{H}_{₂}ₛ):

$$\begin{matrix}{α}_{{H}_{2} = {Q}_{{H}_{2}}^{OUT} / {Q}_{{H}_{2} S}^{IN}} & ( 3 \text{-} 9 ) \\ {ɛ}_{{H}_{2}} = \frac{P}{{Q}_{{H}_{2}}^{OUT}} & ( 3 \text{-} 10 ) \\ {ɛ}_{{H}_{2} S} = \frac{P}{{Q}_{{H}_{2} S}^{IN} - {Q}_{{H}_{2} S}^{OUT}} & ( 3 \text{-} 11 )\end{matrix}$$

In equation 3-9, the H₂ yield is specifically determined by the number of H atoms in the H₂ flow rate out and the number of incoming H atoms. SEI is still used for comparison in analysis.

### Example 4

### Results

### Example 4.1

### Comparison of Tangential and Axial Addition of Oxygen in GAP

The effect of tangential and axial addition was studied in GAP. The reason for studying both tangential and axial addition was because results in previous studies indicated that there may be beneficial effects when injecting gas directly into the hot zone rather than premixing. The main effect is believed to be stabilization of the discharge.

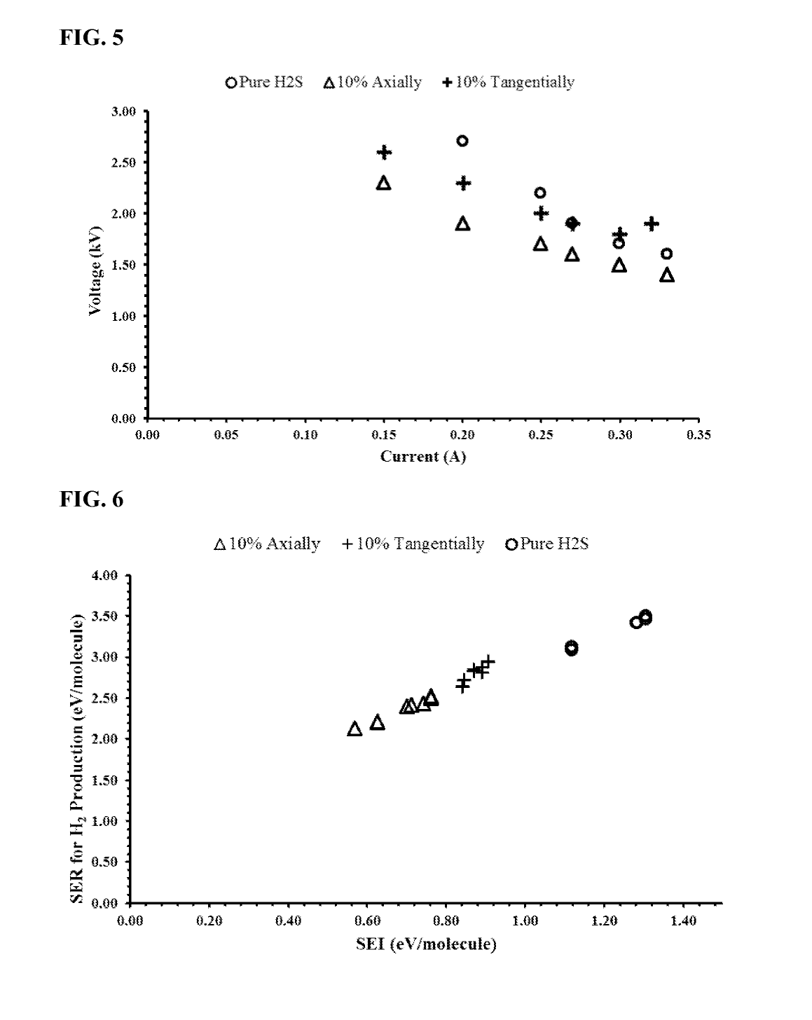

V-I characteristics for GAP in pure H₂S (8.6 L/min) and H₂S with tangential and axial addition of 10% oxygen are presented in FIG. 5. The V-I characteristics of pure H₂S and 10% tangential addition showed that at low specific energy input, the admixture resulted in lower voltage than pure H₂S; however, at higher specific energy input, the admixture crossed the pure H₂S curve and had higher voltage than pure H₂S. The V-I characteristics of pure H₂S and 10% axial oxygen addition were distinct. Throughout the entire range of SEI, the V-I characteristics of H₂S with axial addition of 10% oxygen were lower than those of pure H₂S. This difference was most distinct at lower SEI, while at higher SEI the difference was less noticeable. This difference may be attributed to mixing oxygen in the hot zone, which resulted in a stabilization of the discharge by increasing its temperature and consequently increasing electric conductivity. At higher specific energy input and correspondingly higher temperature, this effect will diminish as the higher gas temperature relaxes the V-I characteristics.

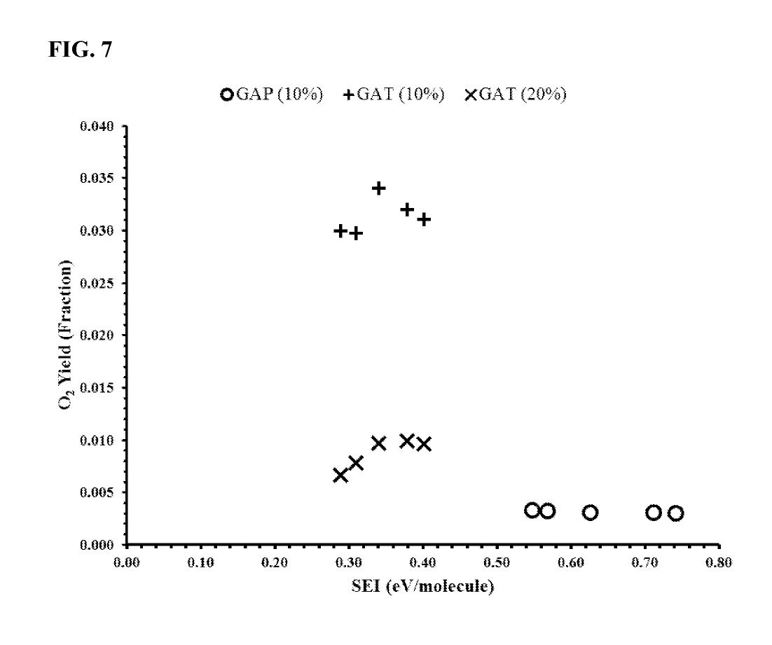

The minimum SER of H₂ production was determined to be 2.1 eV/molecule at atmospheric pressure in GAP (FIG. 6). This value was obtained in GAP at a flow rate of 8.6 L/min, a power of 0.345 kW, and 10% axial O₂ addition. Under these conditions, hydrogen yield was found to be 27%, water production was found to be 19%, and no measurable SO₂ was produced. This result was compared with both tangential O₂ addition and pure H₂S under the same conditions in FIG. 6. Additionally, the minimum SER of H₂S removal was determined to be 0.87 eV/molecule, and H₂S destruction was nearly 50%. Results at lower SEI could not be obtained because GAP could not operate in a stable mode at flow rates greater than 8.6 L/min. GAP with axial O₂ addition operated at lower SER when compared with GAP with tangential addition. This difference occurred because mixing oxygen in the hot zone resulted in a stabilization of the discharge, lowering the required SEI for operation.

### Example 4.2

### Effect of Oxygen Addition on Product Composition in GAT

Further study with H₂S—O₂ mixtures was completed in GAT. GAT was used because it was the only reactor capable to operating at the optimum flow rate from past experiments. The reason GAT could operate under these conditions (and GAP could not) was because the GAT had a movable electrode, which allowed for operation at the short electrode gap distance necessary for sustaining the H₂S discharge at 14 L/min. In addition, thermodynamic modeling indicated that oxygen addition of less than 10% did not improve results significantly, so this study focused solely on 10 and 20% oxygen addition.

Unreacted oxygen was observed in the exhaust of both GAT and GAP. This unreacted oxygen should create discrepancies between modeling (FIG. 7), where almost all oxygen reacts, and experiments, were a significant portion passes through the plasma reactor without reacting. The reason for this unreacted oxygen may be attributed to the role of gas contact with plasma. In the case of GAT, a significant portion of the entire gas flow can pass through the reactor periphery without interacting with plasma, and as a result, it did not react. In the case of GAT, the amount of unreacted oxygen was significantly higher than in the case of GAP. For 10% admixture, unreacted oxygen varied from 2.8% to 3.5% in GAT, while the 20% admixture, contained unreacted oxygen which varied from 0.6% to 1%. GAP with axial O₂ addition had the least unreacted oxygen and was always lower than 0.5% though those data points were acquired at higher SEI (FIG. 7).

In GAT, significantly more oxygen remained unreacted for 10% oxygen addition (3% unreacted at 10% O₂ addition compared with 0.9% unreacted in 20% O₂ addition). This could be the result of overall reactor temperature, which, in the case of 20% oxygen, was significantly higher than in the case of 10% oxygen. The temperature at the exit of the reactor during experiments with 20% O₂ addition may have been high enough to stimulate post discharge combustion of produced hydrogen in oxygen that passed around the discharge without reaction. Taking this into account, less unreacted O₂ would be expected in the case of axial O₂ addition directly into the hot zone as was observed in experiments with GAP (FIG. 7)

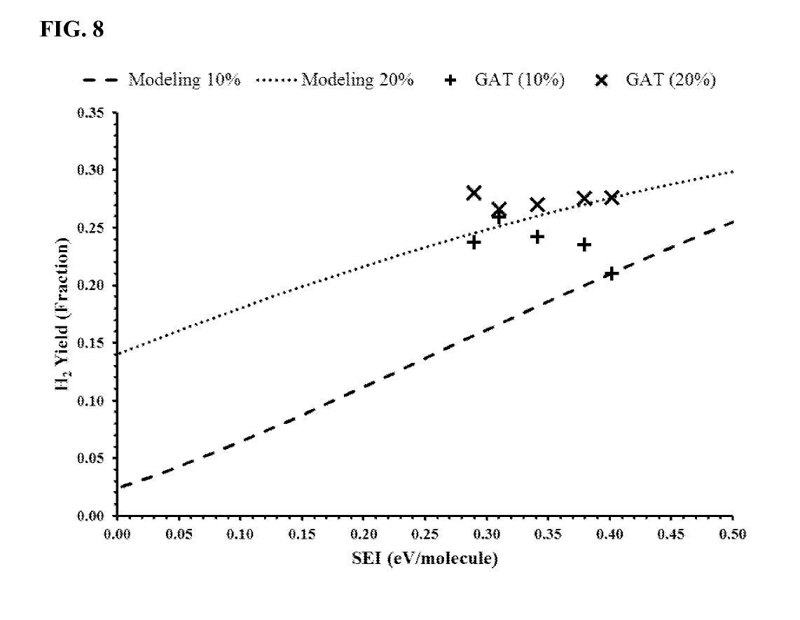

The effect of 10 and 20% oxygen addition on H₂ yield was studied and compared with thermodynamic modeling (FIG. 8). For 10% oxygen addition, experimental H₂ production was significantly higher than was predicted by thermodynamic modeling. This can be explained by the fact that unreacted oxygen was found in the exhaust. Since a significant portion of the incoming oxygen did not participate in reactions, less H₂ was consumed than in the case of thermodynamic modeling when almost all oxygen participates in combustion. For 20% oxygen addition, experimental H2 production was only slightly higher than was predicted by thermodynamic modeling, which makes sense as only a small portion of H₂ remained unreacted. It is not surprising that higher production of hydrogen was observed in experiments than was predicted by 0-D modeling. This behavior was observed in the previous study on pure H₂S, and can be caused by gas-dynamic effects or high diffusion coefficient of hydrogen.

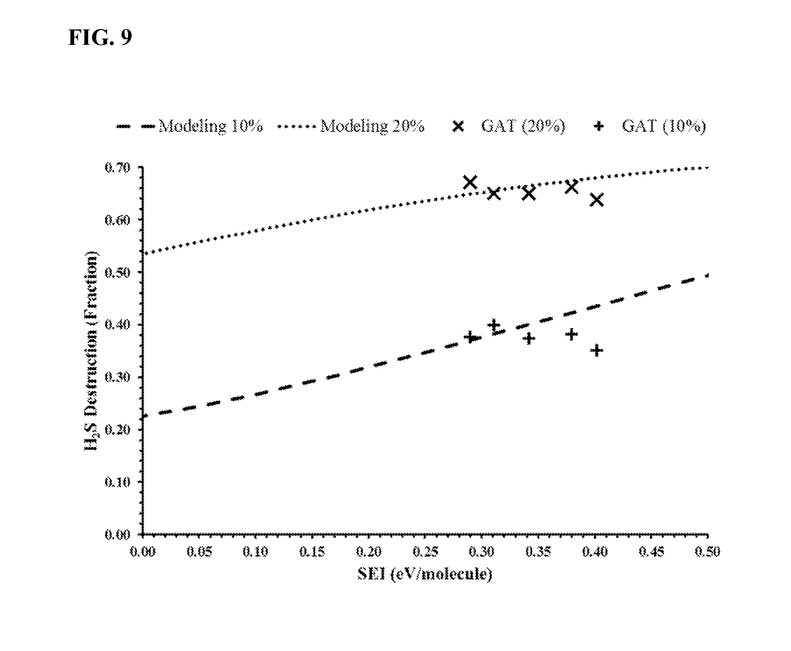

The effect of 10 and 20% O₂ addition on H₂S destruction was also studied and compared with thermodynamic modeling (FIG. 9). For 10% and 20% oxygen addition, experimental H₂S destruction was lower than what is predicted by thermodynamic modeling. Considering FIG. 7 to FIG. 9, H₂ yield was higher than predicted by thermodynamics, and H₂S destruction was lower than predicted by thermodynamics. This correlation can be explained by the observation of unreacted oxygen in the exhaust. Since a portion of the incoming oxygen did not react, less H₂S was destroyed than in the case of thermodynamic modeling (when almost all oxygen reacts).

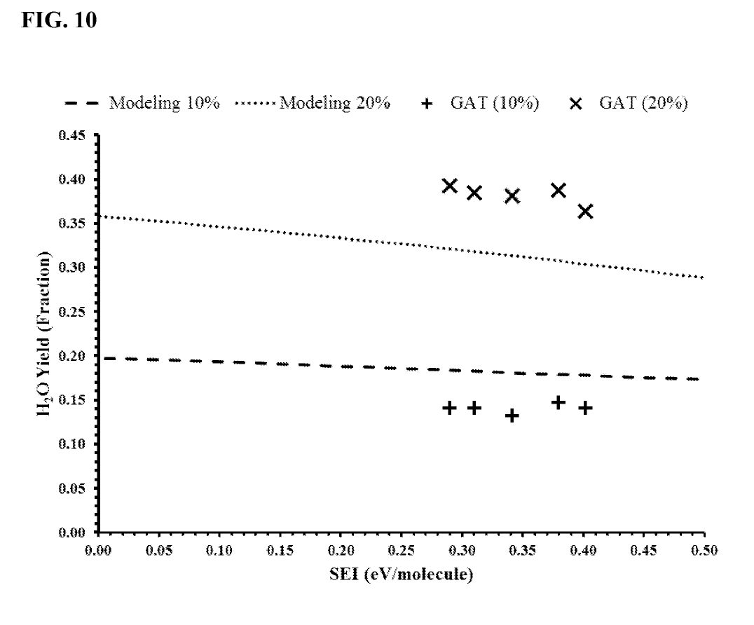

The effect of 10% and 20% oxygen addition on H₂O yield was studied and compared with thermodynamic modeling (FIG. 10). For 10% oxygen addition, experimental H₂O yield was significantly lower than was predicted by thermodynamic modeling. Again, this can be explained by the fact that unreacted oxygen was found in the exhaust. Since a significant portion of the incoming oxygen did not react, less H₂O was produced than in the case of thermodynamic modeling (when almost all oxygen reacts).

In the case of 20% of oxygen addition, significantly higher H₂O yield was observed than was predicted by thermodynamics. Again, in this case, the temperature at the exit of the reactor is high enough to stimulate the oxidation of H₂. Consequently, produced H₂ is consumed in the reaction with O₂ after the plasma discharge. As a result, less H₂S destruction is observed, less H₂ yield is observed and H₂O yield is higher than predicted by thermodynamics.

No SO₂ was detected by the GC in these experiments. The maximum amount of SO₂ predicted by modeling was 3.2%. The detection limit of the GC is 0.01%. As a result, it can be concluded that SO₂ production in this process is less than 0.01%, which is significantly less than predicted by thermodynamic modeling. This discrepancy is likely related to the process kinetics which was not considered in modeling.

### Example 4.3

### Effect of Oxygen Addition on SER in GAT

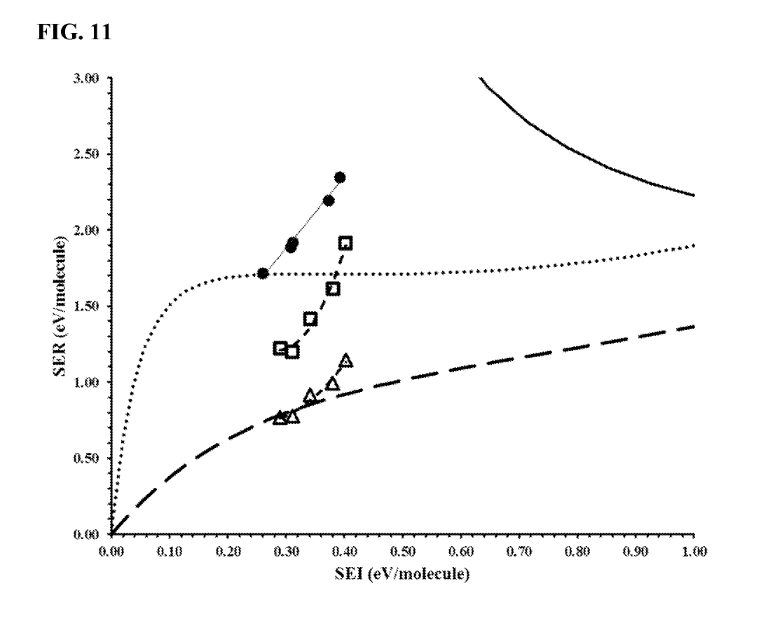

The minimum SER of H₂ production for 10% O₂ addition was found to be 1.2 eV/molecule at atmospheric pressure (FIG. 11). This value was obtained in GAT at a flow rate of 14 L/min and SEI of 0.31 eV/molecule. At the same conditions, the minimum SER of H₂S destruction was found to be 0.76 eV/molecule (FIG. 11). Under these conditions, hydrogen yield was observed to be 24%, water production was observed to be 14%, H₂S destruction was observed to be 38%, and no measureable SO₂ was detected. SER for H₂ production was significantly less than predicted by thermodynamic modeling, in the experimental range of SEI, 1.7 eV/molecule. SER for H₂S destruction was very close to the values predicted by thermodynamic modeling, in the experimental SEI range: i.e., 0.77 eV/molecule in modeling and 0.76 eV/molecule in the experiment. The difference was less than the experimental error, which was about 0.1 eV/molecule

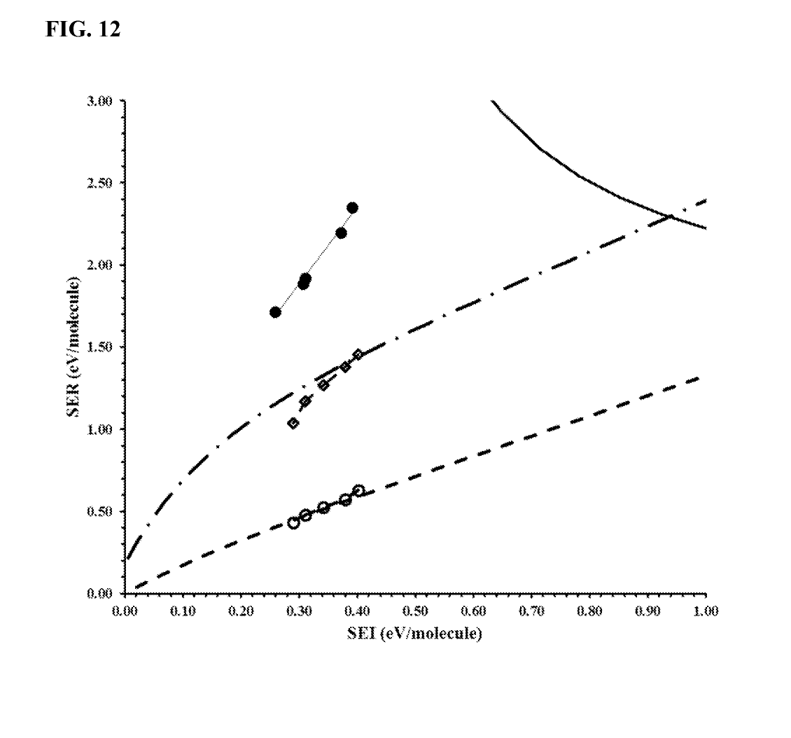

The minimum SER of H₂ production for 20% O₂ addition was found to be 1.0 eV/molecule at atmospheric pressure (FIG. 12). This value was obtained in GAT at a flow rate of 14 L/min, and SEI of 0.29 eV/molecule. At the same conditions, the minimum SER of H₂S destruction was found to be 0.43 eV/molecule (FIG. 12). Under these conditions, hydrogen yield was observed to be 27%, water production was observed to be 38%, H₂S destruction was observed to be 65%, and no measureable SO₂ was detected. SER for H₂ production was only slightly less than what is predicted by thermodynamic modeling in the experimental range of SEI: 1.2 eV/molecule in modeling and 1.0 eV/molecule in the experiment. SER for H₂S production is slightly higher than the values predicted by thermodynamic modeling in the experimental SEI range: 0.4 eV/molecule in modeling and 0.43 eV/molecule in the experiment.

Although 20% oxygen addition was observed to provide the lowest cost values for H₂ production and H₂S destruction, the SER of H₂ production was only slightly less than what was predicted by thermodynamic modeling. Furthermore, the SER for H₂S destruction was slightly higher than thermodynamics. Therefore, while 10% O₂ addition resulted in additional H₂ production when compared with modeling, 20% O₂ addition resulted in nearly identical H₂ production when compared with modeling (FIG. 8). At 20+%, it would be expected that even less H₂ production would be observed, which is not desirable as it was essentially approaching the Claus process (complete combustion of H₂S). In addition, high oxygen addition causes partial hydrogen combustion and further gas temperature increase at the exit of the system, which can cause equipment reliability problems. As a result, O₂ addition of over 20% was not pursued in this study.

### Example 4.4

### Air Addition

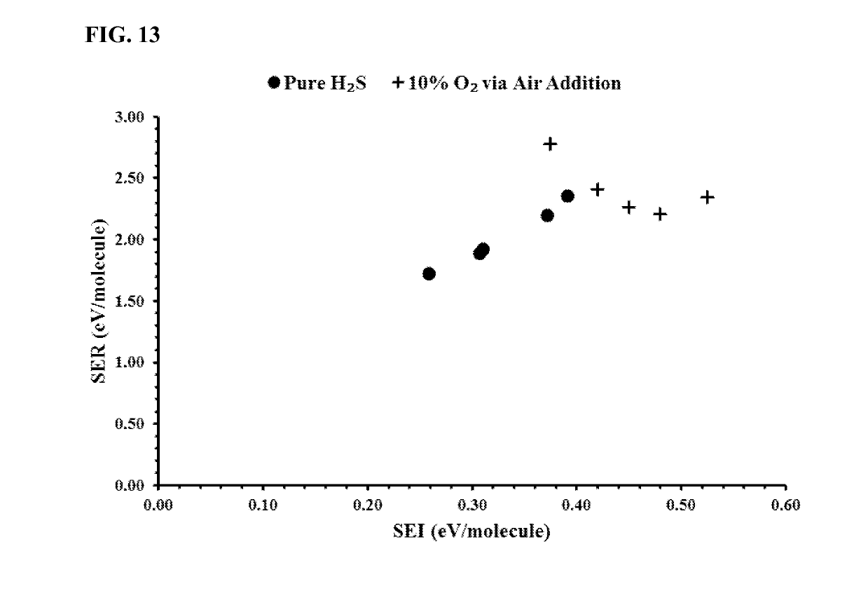

The use of an air admixture was also studied briefly during the investigation. In the case of air addition, the admixture was composed such that 10% O₂ was provided as air, which resulted in a significant portion of N₂ in the inlet and outlet gas composition. FIG. 13 provides a comparison of the 10% air admixture with pure H₂S. The minimum SER for the 10% air admixture was found to be 2.2 eV/molecule, which is significantly higher than pure H₂S (1.7 eV/molecule). The increase in energy cost is primarily attributed to N₂ dilution because the high N₂ content in the gas acts as a heat sink, absorbing plasma energy, which would otherwise result in dissociation of H₂S. Since the results with the air admixture were not as promising as the oxygen admixtures, they were not investigated in detail in this study.

### Example 5

### Discussion

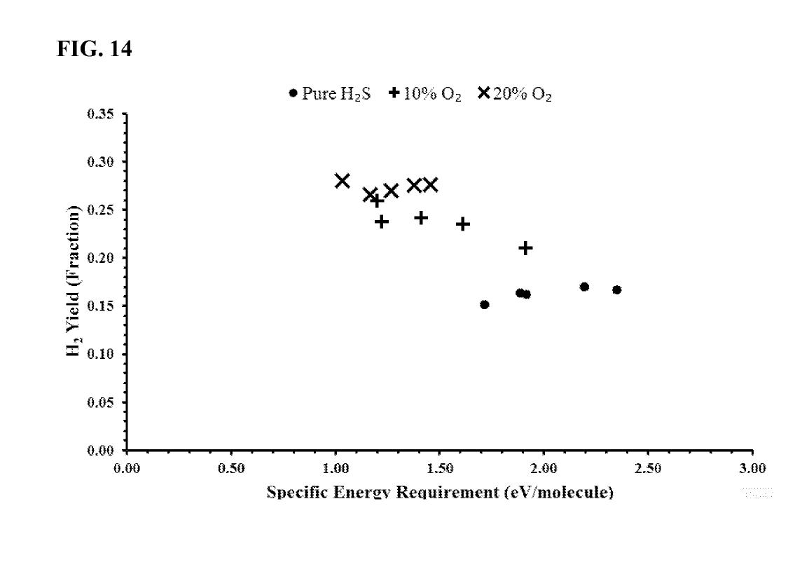

The purpose of the study herein was to develop and study a plasma process that can demonstrate increased H₂S conversion, while simultaneously reducing SER and maintaining similar H₂ production when compared with plasma dissociation of pure H₂S. FIG. 14 provides trends for H₂ yield versus specific energy requirement for pure H₂S and oxygen admixtures. The Figure demonstrates that oxygen admixtures not only permitted operation at lower specific energy requirement, but also resulted in increased H₂ yield. A significant increase of 5-10% in H₂ yield was observed in the 10% admixture when compared with pure H₂S. The 20% admixture resulted in an increase of 12-15% in H₂ yield when compared with pure H₂S. Furthermore, the minimum SER for H₂ production was found to be 1.7 eV/molecule of pure H₂S, while the 10% and 20% admixtures were found to be 1.2 eV/molecule and 1.0 eV/molecule, respectively. Therefore, the O₂ admixtures demonstrated both reduced SER and increased H₂ production, when compared with pure H₂S.

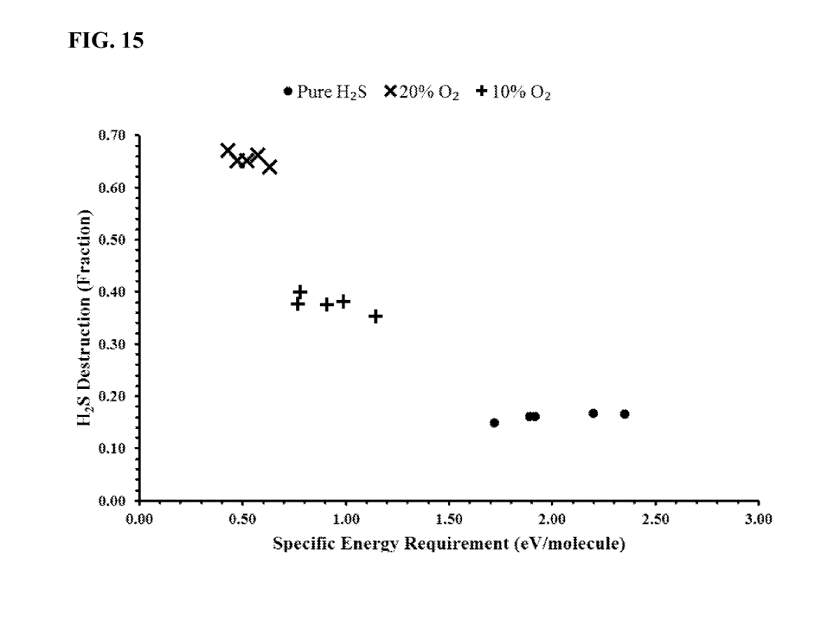

FIG. 15 provides trends for H₂S destruction versus specific energy requirement for pure H₂S and O₂ admixtures. The Figure further illustrates that oxygen admixtures permitted operation with significantly increased H₂S destruction. When compared with pure H₂S, an increase of 25% in H₂S destruction was observed in the 10% admixture. Furthermore, the 20% admixture resulted in a 45% increase in H₂S destruction when compared with pure H₂S. Therefore, the O₂ admixtures demonstrated increased H₂S destruction, when compared with pure H₂S.

The combination of FIG. 14 and FIG. 15 shows that the goal of the process development was achieved as the figures demonstrate the ability of oxygen admixtures to simultaneously reduce SER and increase both H₂ production and H₂S destruction when compared with process in pure H₂S.

Other findings also warrant further discussion. From the standpoint of comparison with thermodynamic modeling, 10% oxygen addition was interesting because it operated with an SER of H₂ production that was significantly less than predicted by thermodynamic modeling (FIG. 11). Simplified computational fluid dynamic (CFD) simulation have showed that this effect can be attributed to high diffusion rate of hydrogen that escapes from plasma and thus shifts chemical reaction equilibrium to product formation. These results will be published as a separate publication in the future. As a result, the authors assert that the process studied herein is not a plasma-assisted combustion process. Instead, plasma acts as the primary source of energy and reactions, while oxidation adds energy that stimulates further H₂S destruction. Thus it can be considered as a combustion-assisted plasma process. To validate this, both the plasma energy (SEI) and H₂ combustion energy were calculated. At 10% O₂ addition, the minimum SEI of 0.31 eV/molecule was achieved, while the corresponding combustion energy was 0.27 eV/molecule in the case of complete oxygen consumption. Therefore, both plasma and combustion provide substantial contributions to the process. Furthermore, it should be noted that, even in the case of oxygen addition, the system appears to retain the non-equilibrium nature of warm plasma, which is ideal for hydrogen production from hydrogen sulfide and other fuel conversion processes.

The ability to achieve the above results with less than 0.01% SO₂ was interesting and unexpected. Modeling predicted 1% SO₂ concentration at 10% oxygen addition and 3.2% at 20% oxygen addition. This discrepancy was likely related to the process kinetics which was not considered in modeling. For example, the “catalytic” nature of the boundary layer of the plasma discharge was not considered in the model. This boundary layer's “catalytic” nature could behave much like the second stage of the Claus process, which would result in lower SO₂ concentrations during experiments when compared with modeling predictions.

In summary, the study has successfully demonstrated that utilizing oxygen admixtures for plasma dissociation of H₂S can demonstrate increased H₂S conversion, while simultaneously reducing SER and maintaining similar H₂ production, when compared with plasma dissociation of pure H₂S. Furthermore, these experimental results, from experiments with H₂S—O₂ mixtures in a warm plasma discharge, were quite promising. The addition of oxygen resulted in reduction of SER for H₂ production to 1.0 eV/molecule. In addition, SER for H₂S destruction was observed to be as low as 0.43 eV/molecule. These values were very low and were very close to the best values reported in microwave discharges at low pressure. Finally, these results were very promising for industry, as they confirmed the ability to reduce energy cost for H₂ production while maintaining the same value of H₂ production and simultaneously increasing H₂S destruction in the system. Also, these low values were achieved without detection of SO₂ in the product gas. This is very desirable from an industrial standpoint, where the processing and recycling of H₂S is a very costly process.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. In addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

1. A method of producing hydrogen and sulfur from the destruction of hydrogen sulfide, said method comprising:
(a) injecting a stream of hydrogen sulfide (H₂S)-containing gas and a stream of oxygen (O₂) or oxygen-rich gas into a reactor, said reactor having a plasma zone therein;
said gas streams being wholly or partially combined with one another before or during contact with the plasma;
wherein the molar ratio of hydrogen sulfide to oxygen injected into the reactor is in a range of from about 3 to about 100; and
said plasma providing an energy to the reactor with the H₂S/O₂ gas streams in a range of about 0.1 to about 1.5 eV per H₂S molecule;
said method providing hydrogen at a specific energy requirement of less than about 2.5 eV/molecule of H₂.

2. The method of claim 1, wherein the oxygen or oxygen-rich gas stream is injected into the reactor separately from at least part of the hydrogen sulfide stream.

3. The method of claim 1, wherein the method being is conducted in a cylindrical, tornado reactor.

4. The method of claim 1, wherein the plasma is a non-equilibrium plasma.

5. The method of claim 4, wherein the plasma zone is generated using a (rotating) gliding arc discharge, low current arc discharge, corona discharge, glow discharge, dielectric barrier discharge, spark discharge, pulsed corona, radio-frequency capacitively coupled discharge, or microwave discharge.

6. The method of claim 1, wherein the gas streams are directed to position the plasma zone at or near an axis of the reaction chamber.

7. The method of claim 1, wherein the streams of hydrogen sulfide (H₂S) gas and a stream of oxygen (O₂) or oxygen-rich gas are injected into the reactor to form a vortex flow of gases within the reactor.

8. The method of 7, wherein the vortex flow is a reverse-vortex flow.

9. The method of claim 1, wherein the stream oxygen (O₂) or oxygen-rich gas is injected directly into the plasma zone, separately from at least a part of the H₂S stream.

10. The method of claim 1, wherein the temperature of an inner surface of the reaction chamber is lower than the temperature of the plasma zone thereby establishing a temperature differential across the reaction chamber.

11. The method of claim 1, wherein the plasma zone causes at least a portion of the hydrogen sulfide to dissociate into gaseous sulfur and gaseous hydrogen.

12. The method of claim 11, wherein the flow of gases is directed such that the gaseous sulfur migrates from the plasma outward radially in a direction towards an inner surface of the reaction chamber.

13. The method of claim 12, wherein the temperature of the reactor sidewall is sufficiently low as to condense the gaseous sulfur on its approach to or contact with the inner surface.

14. The method of claim 1, wherein
the oxygen-rich gas stream contain less than 50 mol % of a ballast gas.

15. The method of claim 1, wherein the method is conducted at a pressure in a range of from about 0.5 to about 10 atm.

16. The method of claim 1, wherein the molar ratio of hydrogen sulfide to oxygen injected into the reactor is in a range of from about 5 to about 100.

17. The method of claim 1, wherein the molar ratio of hydrogen sulfide to oxygen injected into the reactor is in a range of from about 4 to about 30.

18. The method of claim 1, wherein the plasma provides an energy to the reactor with the H₂S/O₂ gas streams in a range of about 0.2 to about 1 eV per H₂S molecule.

19. The method of claim 1, wherein the method results in the production of less than about 1% SO₂, relative to the original H₂S content.
